(19) United States
(12) Patent Application Publication
(10) Pub. No.: US 2024/0340991 A1
(43) Pub. Date: Oct. 10, 2024

(54) METHOD AND APPARATUS FOR MEASURING QOE IN RRC INACTIVE MODE AND RRC IDLE MODE IN WIRELESS COMMUNICATION SYSTEM

(71) Applicant: Samsung Electronics Co., Ltd., Suwon-si (KR)

(72) Inventors: Seungbeom JEONG, Suwon-si (KR); Sangyeob JUNG, Suwon-si (KR)

(21) Appl. No.: 18/621,528

(22) Filed: Mar. 29, 2024

(30) Foreign Application Priority Data
Apr. 5, 2023 (KR) 10-2023-0044822

(51) Int. Cl. H04W 76/20; H04W 24/10; H04W 76/40

(52) U.S. Cl. CPC H04W 76/20; H04W 24/10; H04W 76/40

(57) ABSTRACT

The disclosure relates to a 5G or 6G communication system for supporting a higher data transmission rate. A method performed by a base station in a wireless communication system is provided. The method includes transmitting, to a terminal, a first radio resource control (RRC) message including configuration information associated with an application layer measurement of the terminal, transmitting, to the terminal, a second RRC message including report information associated with a report of the application layer measurement performed in an RRC inactive or an RRC idle; and receiving, from the terminal, a measurement report associated with the application layer measurement performed in the RRC inactive or the RRC idle, wherein the configuration information is applied to the RRC idle or the RRC inactive.

### CROSS-REFERENCE TO RELATED APPLICATION(S)

This application is based on and claims priority under 35 U.S.C. § 119 (a) of a Korean patent application number 10-2023-0044822, filed on Apr. 5, 2023, in the Korean Intellectual Property Office, the disclosure of which is incorporated by reference herein in its entirety.

### BACKGROUND

### 1. Field

The disclosure relates to quality of experience (QoE) measurement and report. More particularly, the disclosure relates to measuring and reporting QoE in inactive mode and/or idle mode.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHZ, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an improved method for measuring and reporting QoE.

Another aspect of the disclosure is to provide an improved method for measuring and reporting QoE in inactive mode and/or idle mode.

Additional aspects will be set forth in part in the description which follows and, in part, will be apparent from the description, or may be learned by practice of the presented embodiments.

In accordance with an aspect of the disclosure, a method performed by a base station in a wireless communication system is provided. The method includes transmitting, to a terminal, a first radio resource control (RRC) message including configuration information associated with an application layer measurement of the terminal, transmitting, to the terminal, a second RRC message including report information associated with a report of the application layer measurement performed in an RRC inactive or an RRC idle, and receiving, from the terminal, a measurement report associated with the application layer measurement performed in the RRC inactive or the RRC idle, wherein the configuration information is applied to the RRC idle or the RRC inactive.

In accordance with another aspect of the disclosure, a method performed by a terminal in a wireless communication system is provided. The method includes receiving, from a base station, a first radio resource control (RRC) message including configuration information associated with an application layer measurement of the terminal, performing the application layer measurement in an RRC inactive or an RRC idle based on the first RRC message, receiving, from the base station, a second RRC message including report information associated with a report of the application layer measurement, and transmitting, to the base station, a measurement report associated with the application layer measurement, wherein the configuration information is applied to the RRC idle or the RRC inactive.

In accordance with another aspect of the disclosure, a base station of a wireless communication system is provided. The base station includes a transceiver and a controller configured to transmit, to a terminal, a first radio resource control (RRC) message including configuration information associated with an application layer measurement of the terminal, to transmit, to the terminal, a second RRC message including report information associated with a report of the application layer measurement performed in an RRC inactive or an RRC idle, and to receive, from the terminal, a measurement report associated with the application layer measurement performed in the RRC inactive or the RRC idle, and wherein the configuration information is applied to the RRC idle or the RRC inactive.

In accordance with another aspect of the disclosure, a terminal of a wireless communication system is provided. The terminal includes a transceiver and a controller configured to receive, from a base station, a first radio resource control (RRC) message including configuration information associated with an application layer measurement of the terminal, perform the application layer measurement in an RRC inactive or an RRC idle based on the first RRC message, receive, from the base station, a second RRC message including report information associated with a report of the application layer measurement, and transmit, to the base station, a measurement report associated with the application layer measurement, wherein the configuration information is applied to the RRC idle or the RRC inactive.

In accordance with another aspect of the disclosure, a method for configuring a new parameter for measuring and reporting QoE in an inactive mode and/or idle mode, measuring QoE using the parameter, and measuring QoE using radio access network (RAN) visible QoE (RVQoE), and reporting the measured QoE, and an apparatus for performing the method are provided.

According to various embodiments of the disclosure, an improved method for measuring and reporting QoE is provided.

In addition, according to various embodiments of the disclosure, a method for measuring and reporting QoE in inactive mode and/or idle mode and apparatus performing the method are provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating a structure of a wireless communication system according to an embodiment of the disclosure;

FIG. 2 is a view illustrating a radio access state transition in a wireless communication system according to an embodiment of the disclosure;

FIG. 3 is a view for explaining an operation for configuring and/or reporting a signaling-based QoE measurement according to an embodiment of the disclosure;

FIG. 4 is a view for explaining a procedure for configuring and/or reporting a management-based QoE measurement according to an embodiment of the disclosure;

FIG. 5 is a flowchart illustrating a procedure for configuring and reporting a radio access network (RAN) visible QoE measurement according to an embodiment of the disclosure;

FIG. 6 is a view for explaining an internal structure of a UE according to an embodiment of the disclosure;

FIG. 7 is a view for explaining a structure of a base station according to an embodiment of the disclosure; and

FIG. 8 is a diagram illustrating a procedure for sending application layer measurement reports to the network according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

All terms used herein, including technical and scientific terms, have the same meaning as those commonly understood by a person skilled in the art to which the disclosure pertains. The terms as those defined in a generally used dictionary among the terms used in the disclosure may be interpreted to have the meanings equal to the contextual meanings in the relevant field of art, and are not to be interpreted to have ideal or excessively formal meanings unless clearly defined in the disclosure. Accordingly, even the term defined in the disclosure should not be interpreted to exclude embodiments of the disclosure.

Hereinafter, various embodiments of the disclosure will be described based on an approach of hardware. However, various embodiments of the disclosure include a technology that uses both hardware and software, and thus the various embodiments of the disclosure may not exclude the perspective of software.

Terms (control unit, processor, artificial intelligence (AI) model, encoder, decoder, autoencoder (AE), neural network (NN) model, etc.) that refer to components of a device used in the following description, and terms (signal, feedback, report, reporting, information, parameter, value, bit, codeword, etc.) that refer to data are illustrated for convenience of description. Accordingly, the disclosure is not limited to the terms described below, and other terms having equivalent technical meanings may be used.

Also, although the disclosure describes various embodiments by using terms used in some communication standards (e.g., 3rd Generation Partnership Project (3GPP)), this is only an example for explanation. Various embodiments of the disclosure may be easily modified and applied to other communication systems.

Hereinafter, embodiments of the disclosure will be described in detail with reference to the accompanying drawings. It should be noted that, in the drawings, the same or like elements are designated by the same or like reference signs as much as possible. Furthermore, a detailed description of known functions or configurations that may make the subject matter of the disclosure unclear will be omitted.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in the embodiments of the disclosure, the term “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card.

Terms for identifying an access node, terms indicating network entities, terms indicating messages, terms indicating an interface between network entities, and terms indicating various identification information, which are used in the following description, are exemplified for convenience of description. Accordingly, the disclosure is not limited to terms to be described later, and other terms indicating objects having the equivalent technical meaning may be used.

In the disclosure, the terms and names defined in the 3rd Generation Partnership Project Long Term Evolution (3GPP LTE) standard or New Radio (NR) standard are used for convenience of explanation. However, the disclosure is not limited by the terms and names, and it can be applied to other standard communication systems in the same manner.

Hereinafter, a base station (BS) may be an entity performing allocating a resource to a UE and may be at least one of a radio access network (RAN), a gNode B (next generation node B, gNB), an eNode B (evolved node B, eNB), a Node B, a wireless access unit, a base station controller, and a node on a network. In the disclosure, an eNB may be interchangeably used with a gNB for convenience of explanation. That is, a base station (BS) described by an eNB may represent a gNB.

Hereinafter, the term “terminal” may include a user equipment (UE), a mobile station (MS), a cellular phone, a smartphone, a computer, or a multimedia system with a communication function. However, it is not limited to the above example.

In particular, the disclosure is applicable to 3GPP NR (5th generation (5G) mobile communication standard). Further, the disclosure is applicable to intelligent services (for example, smart homes, smart buildings, smart cities, smart cars or connected cars, healthcare, digital education, retail businesses, or security and safety related services, etc.) based on a 5G communication technology and an Internet of Things (IoT)-related technology. Also, the term ‘terminal’ may indicate other wireless communication devices as well as mobile phone, NB-IoT devices and sensors.

A wireless communication system deviates from the provision of the initial voice-oriented service and evolves into a broadband wireless communication system which provides high-speed and high-quality packet data services, for example, communication standards such as high speed packet access (HSPA), long term evolution (LTE) or evolved universal terrestrial radio access (E-UTRA), LTE-Advanced (LTE-A), and LTE-Pro of 3GPP, high rate packet data (HRPD) and an ultra mobile broadband (UMB) of 3GPP2, and 802.16e of Institute of Electrical and Electronics Engineers (IEEE).

An LTE system, as a representative example of a broadband wireless communication system, adopts an orthogonal frequency division multiplexing (OFDM) scheme in a downlink (DL), and adopts a single carrier frequency division multiple access (SC-FDMA) scheme in an uplink (UL). The uplink refers to a radio link through which a terminal (or UE) transmits data or a control signal to a base station (or eNB, gNB), and the downlink refers to a radio link through which a base station transmits data or a control signal to a terminal. In the multiple-access scheme as described above, data or control information is distinguished according to users by assigning and managing time-frequency resources for carrying data or control information for each of users, so as not to overlap each other, that is, orthogonality is established.

As a post-LTE communication system, a 5G communication system needs to freely accommodate various requirements of users and service providers, and provide services satisfying various requirements. Services considered for the 5G communication system may include enhanced mobile broadband (eMBB), massive machine type communication (mMTC), ultra-reliable low-latency communication (URLLC), and the like.

According to an embodiment, the eMBB may aim to provide more enhanced data rate compared to a data rate supported by the conventional LTE, LTE-A, or LTE-Pro. For example, the eMBB in the 5G communication system needs to provide a peak data rate of 20 Gbps for a DL, and a peak data rate of 10 Gbps for an uplink, in view of a single base station. In addition, the 5G communication system may need to provide the peak data rate and at the same time provide an increased user perceived data rate. In order to meet these requirements, the improvement of various transmission/reception technologies including more enhanced multi input multi output (MIMO) transmission technology may be required in the 5G communication system. In addition, a signal is transmitted using the maximum transmission bandwidth of 20 MHZ in the 2 GHz band used by current LTE, however, the 5G communication system uses a frequency bandwidth wider than 20 MHz in the frequency band of 3 to 6 GHz or 6 GHz or more, and thus a data rate required in the 5G communication system may be satisfied.

At the same time, in order to support application services such as Internet of Things (IoT) in the 5G communication system, mMTC is being considered. The mMTC may require large terminal access support in a cell, terminal coverage improvement, enhanced battery time, reduced terminal cost, and the like, in order to efficiently provide the IoT. In the IoT, since the terminal is attached to various sensors and devices to provide a communication function, the IoT needs to support a large number of terminals (for example, 1,000,000 terminals/km\hat{ }2) in a cell. Further, since, in consideration of the characteristic of the service, the terminal supporting the mMTC is likely to be located in a shaded area where a cell cannot cover, such as the basement of a building, broader coverage may be required than other services provided by the 5G communication system in the mMTC. A low-cost terminal may be required for the terminal supporting the mMTC, and a very long battery life time of 10 to 15 years may be required in the mMTC since it is difficult to frequently replace the battery of the terminal.

Finally, the URLLC is a cellular-based wireless communication service used for a mission-critical purpose, and may be used in services used in remote control for a robot or machinery, industrial automation, unmanned aerial vehicles, remote health care, emergency alerts, and the like. Accordingly, the communication provided by the URLLC may need to provide very low latency (ultra-low latency) and very high reliability (ultra-high reliability). For example, services supporting the URLLC may need to meet air interface latency less than 0.5 milliseconds, and also need to have a requirement of packet error rate of 10\hat{ }-5 or less. Therefore, for services supporting the URLLC, the 5G system may need to provide a transmit time interval (TTI) smaller than that of the other services, and a design requirement for assigning a wider resource in the frequency band to secure the reliability of the communication link may be required as well in the 5G system.

Three services considered in the above-described 5G communication system, i.e., eMBB, URLLC, and mMTC, may be multiplexed and provided in one system. In this case, different transmission/reception techniques and transmission/reception parameters may be used for respective services to satisfy different requirements of the respective services. However, the above-described mMTC, URLLC, and eMBB are merely examples of different types of services, and types of services which are to be applied according to the disclosure are not limited to the above-described examples.

In addition, in the following description, embodiments of the disclosure will be described by taking LTE, LTE-A, LTE-Pro, 5G (or NR), or 6G system as an example, but embodiments of the disclosure may be applied to other communication systems having a similar technical background or channel form. In addition, embodiments of the disclosure may be applied to other communication systems through some modifications within the scope of without largely departing from the scope of the disclosure by the judgment of those skilled in the art.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

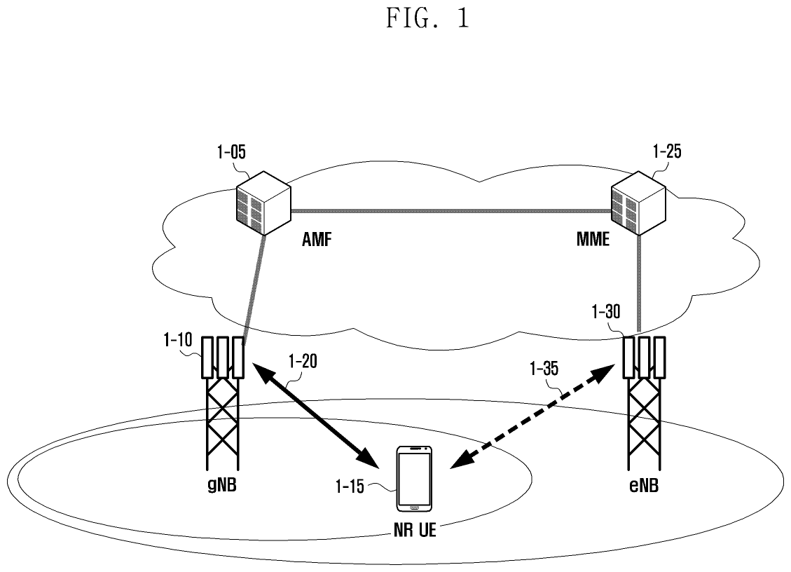

FIG. 1 is a view illustrating a structure of a wireless communication system according to an embodiment of the disclosure.

Referring to FIG. 1, as illustrated, a radio access network of a wireless communication system (new Radio (NR)) may include a next-generation base station (next generation node B, hereinafter, gNB) 1-10 and an access and mobility management function (AMF) 1-05. A user equipment (new radio user equipment, hereinafter, NR UE or terminal) 1-15 may access an external network through the gNB 1-10 and the AMF 1-05.

Referring to FIG. 1, the gNB may correspond to the evolved node B (eNB) of the conventional LTE system. The gNB may be connected to the NR UE via a wireless channel, and provide an enhanced service as compared to the conventional node B (e.g., the eNB) (1-20). In the wireless communication system, all user traffic may be serviced through a shared channel, and thus, a device for performing scheduling by compiling state information such as the buffer state, available transmission power state, and channel state of UEs, and the gNB 1-10 may be responsible for this scheduling. One gNB may usually control a plurality of cells. To implement ultra-high data rate transmission as compared with the conventional LTE, the existing maximum bandwidth or higher may be provided, and the orthogonal frequency division multiplexing (OFDM) may be used as the radio access technology, and beamforming technology may be additionally performed. Further, the adaptive modulation & coding (AMC) scheme that determines a modulation scheme and a channel coding rate in compliance with the channel state of the UE may be applied. The AMF 1-05 may perform functions such as mobility support, bearer configuration, quality of service (QOS) configuration, etc.

The AMF 1-05 is responsible for various control functions as well as the mobility management function for the UE, and may be connected to a plurality of base stations. In addition, the wireless communication system may interwork with the conventional LTE system. The AMF 1-05 may be connected to an MME 1-25 through the network interface. The MME 1-25 may be connected to the conventional base station, an eNB 1-30. The UE supporting LTE-NR dual connectivity may transmit and/or receive data while maintaining connectivity to not only the gNB 1-10 but also the eNB 1-30 (1-35).

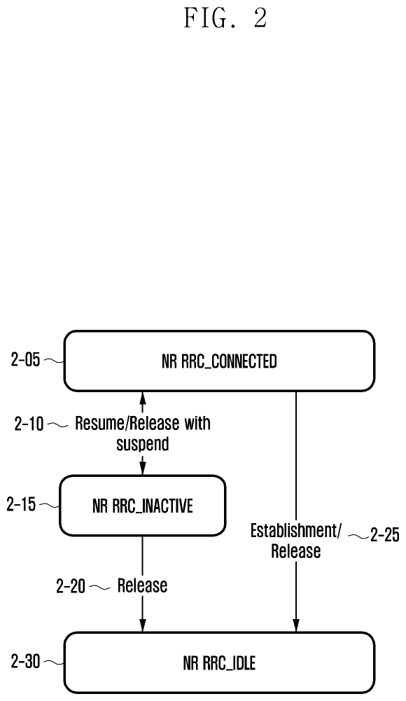

FIG. 2 is a view illustrating a radio access state transition in a wireless communication system according to an embodiment of the disclosure.

Referring to FIG. 2, the wireless communication system may have three radio resource control (RRC) states or RRC mode. The connected mode (RRC_CONNECTED) 2-05 may be a radio access state in which the UE may transmit and/or receive data. The standby mode (RRC_IDLE) 2-30 may be a radio access state in which the UE monitors whether paging is transmitted to itself. The two modes are the radio access states that are also applied to the conventional LTE system, and the detailed description thereof may be similar to that of the conventional LTE system. In the wireless communication system, inactive (RRC_INACTIVE) 2-15 radio access state may be newly defined. In the radio access state, the UE context may be maintained in the base station and the UE, and radio access network (RAN)-based paging may be supported. Features of the new radio access state are listed as follows.
Cell re-selection mobility;
CN-NR RAN connection (both C/U-planes) has been established for UE;
The UE AS context is stored in at least one gNB and the UE;
Paging is initiated by NR RAN;
RAN-based notification area is managed by NR RAN;
NR RAN knows the RAN-based notification area which the UE belongs to;

The new inactive mode may transition to the connected mode or standby mode using a specific procedure. According to a resume process, the inactive mode may be switched to the connected mode, or the connected mode may be switched to the inactive mode using a release procedure including suspend configuration information (2-10). The above procedure may include one or more operations of transmitting and/or receiving one or more RRC messages between the UE and the base station. In addition, the inactive mode may be switched to the idle mode through the release procedure after resume (2-20). Switching between the connected mode and the idle mode may follow LTE technology. That is, switching between the modes may be performed through an establishment or release procedure (2-25).

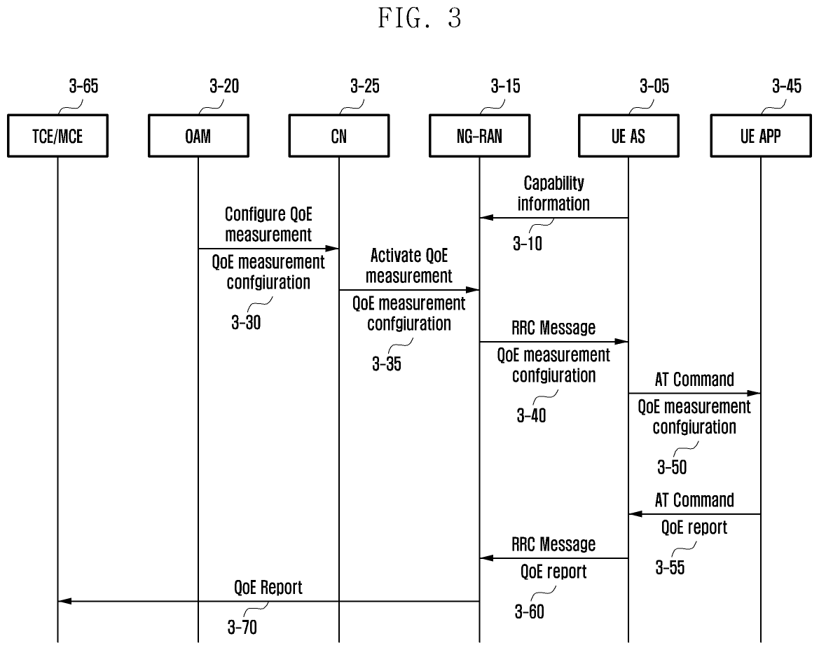

FIG. 3 is a flowchart illustrating a procedure for configuring and/or reporting a signaling-based QoE measurement according to an embodiment of the disclosure.

In the embodiment of FIG. 3, a UE access stratum (AS) 3-05 may be defined as a UE, and the NG-RAN 3-15 may be defined as a base station. The UE AS 3-05 may be defined as the AS layer of the UE, and the UE APP 3-45 may be defined as a UE application layer. Operations performed by the UE AS 3-05 and UE APP 3-45 may be interpreted as operations performed by the UE.

Referring to FIG. 3, in operation 3-10, the UE access stratum (AS) 3-05 may transmit capability information to the NR-RAN 3-15. The capability information may be UE capability information. The UE AS 3-05 may transmit information (e.g., at least one of qoe-Streaming-MeasReport, qoe-MTSI-MeasReport, and qoe-VR-MeasReport) indicating whether QoE measurement is supported according to service types (e.g., at least one of streaming, multimedia telephony service for IP multimedia subsystem (IMS) (MTSI), and VR) to the base station (or the NG-RAN 3-15) through a UE capability message (e.g., UECapabilityInformation) in operation 3-10. Before the UE 3-05 transmits the UE capability message to the base station 3-15, the base station 3-15 may transmit a message (e.g., UECapabilityEnquiry) regarding a request for the UE capability message to the UE 3-05. In addition, through the UE capability message, the UE 3-05 may report to the base station 3-15 whether it supports RAN visible QoE measurement (e.g., at least one of ran-VisibleQoE-Streaming-MeasReport and ran-VisibleQoE-VR-MeasReport) by service type (e.g., streaming, VR). In addition, through the UE capability message, the UE 3-05 may report whether the UE supports UL RRC segmentation of the QoE report message (e.g., ul-MeasurementReportAppLayer-Seg). The UE capability message may include ASN.1 information shown in Table 1 below and a related parameter description as shown in Table 2 below.

TABLE 1

| | |
|---|---|
| QoE-Parameters-r17 ::= | SEQUENCE { |

| | |
|---|---|
| qoe-Streaming-MeasReport-r17 | ENUMERATED {supported} |

OPTIONAL,

| | |
|---|---|
| qoe-MTSI-MeasReport-r17 | ENUMERATED {supported} |

OPTIONAL,

| | |
|---|---|
| qoe-VR-MeasReport-r17 | ENUMERATED {supported} |

OPTIONAL,

| | |
|---|---|
| ran-VisibleQoE-Streaming-MeasReport-r17 | ENUMERATED |

| | |
|---|---|
| {supported} | OPTIONAL, |

| | |
|---|---|
| ran-VisibleQoE-VR-MeasReport-r17 | ENUMERATED {supported} |

OPTIONAL,

| | |
|---|---|
| ul-MeasurementReportAppLayer-Seg-r17 | ENUMERATED |

| | |
|---|---|
| {supported} | OPTIONAL, |

```
    ...
  }
```

TABLE 2

| | | | FDD- | FR1- |
|---|---|---|---|---|
| | | | TDD | FR2 |
| Definitions for parameters | Per | M | DIFF | DIFF |
| qoe-Streaming-MeasReport-r17 | UE | No | No | No |
| Indicates whether the UE supports NR QoE Measurement Collection for streaming | | | | |
| services, see TS 26.247 [29]. | | | | |
| qoe-MTSI-MeasReport-r17 | UE | No | No | No |
| Indicates whether the UE supports NR QoE Measurement Collection for MTSI | | | | |
| services, see TS 26.114 [30]. | | | | |
| qoe-VR-MeasReport-r17 | UE | No | No | No |
| Indicates whether the UE supports NR QoE Measurement Collection for VR | | | | |
| services, see TS 26.118 [31]. | | | | |
| ran-VisibleQoE-Streaming-MeasReport-r17 | UE | No | No | No |
| Indicates whether the UE supports RAN visible QoE Measurement Collection for | | | | |
| streaming services. | | | | |
| ran-VisibleQoE-VR-MeasReport-r17 | UE | No | No | No |
| Indicates whether the UE supports RAN visible QoE Measurement Collection for | | | | |
| VR services. | | | | |
| ul-MeasurementReportAppLayer-Seg-r17 | UE | No | No | No |
| Indicates whether the UE supports RRC segmentation of the | | | | |
| MeasurementReportAppLayer message in UL, as specified in TS 38.331 [9]. | | | | |

Types of services that may be supported in LTE may include streaming and multimedia telephony service for IP multimedia subsystem (IMS) (MTSI), NR system may additionally define support of virtual reality (VR) through Rel-17, and a further release may additionally support multimedia broadcast multicast services (MBMS), extended reality (XR), and the like. The services supportable in the NR system are not limited to above examples.

According to an embodiment of the disclosure, an operations administration and maintenance (OAM) 3-20 may configure QoE measurement to a core network (CN) 3-25. The OAM 3-20 may provide QoE measurement configuration information to the CN 3-25 in operation 3-30. The CN 3-25, which has received the QoE measurement configuration information, may activate QoE measurement. The CN 3-25 may activate the QoE measurement by transmitting the QoE measurement configuration information to the base station 3-15 in operation 3-35. The base station 3-15, which has received the QoE measurement configuration information, may transmit the configuration information to the UE 3-05 through an RRC message (e.g., an RRCReconfiguration or RRCResume message). The RRC message may be transmitted from the base station 3-15 to the UE AS 3-05 in operation 3-40. The RRC message may include information element (IE) (e.g., APPLayerMeasConfig) shown in Table 3 below, and related parameter descriptions may be as shown in Tables 4 and 5 below.

```
TABLE 3
  - AppLayerMeasConfig
  The IE AppLayerMeasConfig indicates configuration of application layer
measurements.
  AppLayerMeasConfig information element
  --ASN1START
  --TAG-APPLAYERMEASCONFIG-START
```

| | |
|---|---|
| AppLayerMeasConfig-r17 ::= | SEQUENCE { |

| | |
|---|---|
| measConfigAppLayerToAddModList-r17 | SEQUENCE (SIZE |

(1..maxNrofAppLayerMeas-r17)) OF MeasConfigAppLayer-r17 OPTIONAL, --
Need N

| | |
|---|---|
| measConfigAppLayerToReleaseList-r17 | SEQUENCE (SIZE |

(1..maxNrofAppLayerMeas-r17)) OF MeasConfigAppLayerId-r17 OPTIONAL, --
Need N

| | |
|---|---|
| rrc-SegAllowed-r17 | ENUMERATED {enabled} |

```
OPTIONAL, -- Need R
    ...
  }
```

| | |
|---|---|
| MeasConfigAppLayer-r17 ::= | SEQUENCE { |
| measConfigAppLayerId-r17 | MeasConfigAppLayerId-r17, |

| | |
|---|---|
| measConfigAppLayerContainer-r17 | OCTET STRING (SIZE (1..8000)) |

OPTIONAL, -- Need N

| | |
|---|---|
| serviceType-r17 | ENUMERATED {streaming, mtsi, vr, spare5, |

spare4, spare3, spare2, spare1} OPTIONAL, -- Need M

| | |
|---|---|
| pauseReporting | BOOLEAN |

OPTIONAL, -- Need M

| | |
|---|---|
| transmissionOfSessionStartStop | BOOLEAN |

OPTIONAL, -- Need M

| | |
|---|---|
| ran-VisibleParameters-r17 | SetupRelease {RAN-VisibleParameters- |

| | |
|---|---|
| r17} | OPTIONAL, -- Need M |

```
    ...
  }
```

| | |
|---|---|
| RAN-VisibleParameters-r17 ::= | SEQUENCE { |
| ran-VisiblePeriodicity | ENUMERATED {ms120, ms240, ms480, |

| | |
|---|---|
| ms640, ms1024} | OPTIONAL, -- Need S |

| | |
|---|---|
| numberOfBufferLevelEntries-r17 | INTEGER (1..8) |

OPTIONAL, -- Need R

| | |
|---|---|
| reportPlayoutDelayForMediaStartup-r17 | BOOLEAN, |

```
OPTIONAL, -- Need M
    ...
  }
  --TAG-APPLAYERMEASCONFIG-STOP
  --ASN1STOP
```

TABLE 4
AppLayerMeasConfig field descriptions

measConfigAppLayerContainer
The field contains configuration of application layer measurements, see Annex L
(normative) in TS 26.247 [68], clause 16.5 in TS 26.114 [69] and TS 26.118 [70].
pauseReporting
The field indicates whether the transmission of measReportAppLayerContainer is paused
or not.
ran-VisibleParameters
The field indicates whether RAN visible application layer measurements shall be reported
or not. The field is optionally present when service Type is set to streaming or vr.
Otherwise, it is absent.
rrc-SegAllowed
This field indicates that RRC segmentation of MeasurementReportAppLayer is allowed. It
may be present only if the UE supports RRC segmentation of the
MeasurementReportAppLayer message in UL.
serviceType
Indicates the type of application layer measurement. Value streaming indicates Quality of
Experience Measurement Collection for streaming services (see TS 26.247 [68]), value
mtsi indicates Quality of Experience Measurement Collection for MTSI (see TS 26.114
[69]). value vr indicates Quality of Experience Measurement Collection for VR service (see
TS 26.118 [70]). The network always configures serviceType when application layer
measurements are initially configured and at fullConfig.
transmissionOfSessionStartStop
The field indicates whether the UE shall transmit indications when sessions in the
application layer start and stop. The UE transmits a session start indication upon
configuration of this field if a session already has started in the application layer.

TABLE 5
RAN-VisibleParameters field descriptions

numberOfBufferLevelEntries
The field contains the maximum number of buffer level entries that can be reported for
RAN visible application layer measurements.
ran-VisiblePeriodicity
The field indicates the periodicity of RAN visible application layer measurements reporting.
Value ms120 indicates 120 ms, value ms240 indicates 240 ms and so on.
reportPlayoutDelayForMediaStartup
The field indicates whether the UE shall report Playout Delay for Media Startup for RAN
visible application layer measurements.

The operation of the UE AS 3-05 that has received the information shown in Table 3 may be as shown in Table 6 below.

TABLE 6
5.3.5.13d Application layer measurement configuration
The UE shall:

| | |
|---|---|
| 1> | if measConfigAppLayerToReleaseList is included in appLayerMeasConfig within |
| | RRCReconfiguration or RRCResume: |

| | |
|---|---|
| 2> | for each measConfigAppLayerId value included in the |
| | measConfigAppLayerToReleaseList: |

| | |
|---|---|
| 3> | forward the measConfigAppLayerId and inform upper layers about the release of |
| | the application layer measurement configuration including any RAN visible |
| | application later measurement configuration; |
| 3> | discard any application layer measurement report received from upper layers; |
| 3> | consider itself not to be configured to send application layer measurement report |
| | for the measConfigAppLayerId. |

| | |
|---|---|
| 1> | if measConfigAppLayerToAddModList is included in appLayerMeasConfig within |
| | RRCReconfiguration or RRCResume: |

| | |
|---|---|
| 2> | for each measConfigAppLayerId value included in the |
| | measConfigAppLayerToAddModList: |

| | |
|---|---|
| 3> | if measConfigAppLayerContainer is included for the corresponding |
| | MeasConfigAppLayer configuration: |

| | |
|---|---|
| 4> | forward the measConfigAppLayerContainer, the measConfigAppLayerId and |
| | the serviceType to upper layers considering the serviceType; |

| | |
|---|---|
| 3> | consider itself to be configured to send application layer measurement report for |
| | the measConfigAppLayerId in accordance with 5.7.16; |
| 3> | forward the transmissionOfSessionStartStop, if configured, and |
| | measConfigAppLayerId to upper layers considering the serviceType; |
| 3> | if ran-VisibleParameters is set to setup and the parameters have been received; |

| | |
|---|---|
| 4> | forward the measConfigAppLayerId, the ran-VisiblePeriodicity, if |
| | configured, the numberOfBufferLevelEntries, if configured, and the |
| | reportPlayoutDelayForMediaStartup, if configured, to upper layers |
| | considering the serviceType; |

| | |
|---|---|
| 3> | else if ran-VisibleParameters is set to release: |

| | |
|---|---|
| 4> | forward the measConfigAppLayerId and inform upper layers about the release |
| | of the RAN visible application layer measurement configuration; |

| | |
|---|---|
| 3> | if pauseReporting is set to true: |

| | |
|---|---|
| 4> | if at least one segment, but not all segments, of a segmented |
| | MeasurementReportAppLayer message containing an application layer |
| | measurement report associated with the measConfigAppLayerId has been |
| | submitted to lower layers for transmission: |

| | |
|---|---|
| 5> | submit the remaining segments of the MeasurementReportAppLayer |
| | message to lower layers for transmission; |

| | |
|---|---|
| 4> | suspend submitting application layer measurement report containers to lower |
| | layers for the application layer measurement configuration associated with the |
| | measConfigAppLayerId; |
| 4> | store any previously or subsequently received application layer measurement |
| | report containers associated with the measConfigAppLayerId for which no |
| | segment, or full message, has been submitted to lower layers for transmission; |

| | |
|---|---|
| 3> | else if pauseReporting is set to false and if transmission of application layer |
| | measurement report containers has previously been suspended for the |
| | application layer measurement configuration associated with the |
| | measConfigAppLayerId: |

| | |
|---|---|
| 4> | submit stored application layer measurement report containers to lower |
| | layers, if any, for the application layer measurements configuration associated |
| | with the measConfigAppLayerId; |
| 4> | resume submitting application layer measurement report containers to lower |
| | layers for the application layer measurement configuration associated with the |
| | measConfigAppLayerId; |

NOTE 1: The UE may discard reports when the memory reserved for storing

application layer measurement reports becomes full.

NOTE 2: The transmission of RAN visible application layer measurement

reports is not paused when pauseReporting is set to true.

The UE AS 3-05, which has received the RRC message, may provide QoE measurement configuration information to the UE APP 3-45 and use the AT command in operation 3-50. As described above, in case of the QoE measurement configuration included in the measConfigAppLayerToAddModList, the UE AS 3-05 may transmit the QoE measurement configuration information to an upper layer or application layer (UE APP) 3-45 of the UE through an AT command in operation 3-50. For the QoE measurement configuration included in the measConfigAppLayerToAddReleaseList, the UE AS 3-05 may send the AT command to delete the stored configuration information to the UE APP 3-45.

The UE APP 3-45 may perform QoE measurement according to the received configuration information. In addition, the UE APP 3-45 may report the QoE report including the measurement results to the UE AS 3-05 through the AT command according to the configuration information in operation 3-55. The UE AS 3-05, which has received the AT command, may report the measurement result to the base station through an RRC message (e.g., a MeasurementReportAppLayer message) in operation 3-60. The UE AS 3-05 may use signaling radio bearer 4 (SRB4) for reporting the QoE measurement result. The MeasurementReportAppLayer message may include ASN.1 information as shown in Table 7 below and related parameter descriptions as shown in Table 8 below.

```
TABLE 7
- MeasurementReportAppLayer
The MeasurementReportAppLayer message is used for sending application layer
measurement report.
  Signalling radio bearer: SRB4
  RLC-SAP: AM
  Logical channel: DCCH
  Direction: UE to Network
    MeasurementReportAppLayer message
    --ASN1START
    --TAG-MEASUREMENTREPORTAPPLAYER-START
    MeasurementReportAppLayer-r17 ::= SEQUENCE {
      criticalExtensions CHOICE {
        measurementReportAppLayer-r17 MeasurementReportAppLayer-r17-
IEs,
        criticalExtensionsFuture SEQUENCE { }
      }
    }
    MeasurementReportAppLayer-r17-IEs ::= SEQUENCE {
      measurementReportAppLayerList-r17
MeasurementReportAppLayerList-r17
      lateNonCriticalExtension OCTET STRING OPTIONAL,
      nonCriticalExtension SEQUENCE{ } OPTIONAL
    }
    MeasurementReportAppLayerList-r17 ::= SEQUENCE (SIZE
(1..maxNrofAppLayerMeas-r17)) OF MeasurementReportAppLayer-r17
    MeasurementReportAppLayer-r17 ::= SEQUENCE {
      measConfigAppLayerId-r17, MeasConfigAppLayerId-r17,
      MeasurementReportAppLayerContainer-r17 OCTET STRING
OPTIONAL,
      appLayerSessionStatus-r17 ENUMERATED {started, stopped}
OPTIONAL,
      ran-VisibleMeasurements-r17 RAN-VisibleMeasurements-r17
OPTIONAL
    }
    RAN-VisibleMeasurements-r17 ::= SEQUENCE {
      appLayerBufferLevelList-r17 SEQUENCE (SIZE (1..8)) OF
AppLayerBufferLevel-r17 OPTIONAL,
      playoutDelayForMediaStartup-r17 INTEGER (0..30000) OPTIONAL,
      pdu-SessionIdList-r17 SEQUENCE (SIZE (1..maxNrofPDU-
Sessions-r17)) OF PDU-SessionID OPTIONAL,
      ...
    }
    AppLayerBufferLevel-r17 ::= INTEGER (0..30000)
    --TAG-MEASUREMENTREPORTAPPLAYER-STOP
    --ASN1STOP
```

TABLE 8
MeasurementReportAppLayer field descriptions

appLayerBufferLevelList
The field indicates a list of application layer buffer levels, and each AppLayerBufferLevel indicates the application
layer buffer level in ms. Value 0 corresponds to 0 ms, value 1 corresponds to 10 ms, value 2 corresponds to 20 ms and
so on. If the buffer level is larger than the maximum value of 30000 (5 minutes), the UE reports 30000.
appLayerSessionStatus
Indicates that an application layer measurement session in the application layer starts or ends.
playoutDelayForMediaStartup
Indicates the application layer playout delay for media start-up in ms. Value 0 corresponds to 0 ms, value 1
corresponds to 1 ms, value 2 corresponds to 2 ms and so on. If the playout delay for media start-up is larger than the
maximum value of 30000 ms, the UE reports 30000.
MeasurementReportAppLayerContainer
The field contains application layer measurement report, see Annex L (normative) in TS 26.247 [68], clause 16.5 in TS
26.114 [69] and TS 26.118 [70].
pdu-SessionidList
Contains the identity of the PDU session, or the identities of the PDU sessions, used for application data flows subject
to the RAN visible application layer measurements.

The QoE measurement result reporting procedure of the UE AS 3-05 may be as shown in Table 9 below. In Table 9 below, the UE corresponds to a terminal or UE AS 3-05, and network corresponds to the NG-RAN 3-15 or a base station.

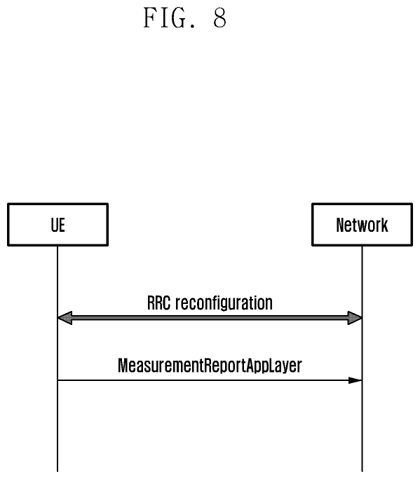

TABLE 9
5.7.16 Application layer measurement reporting
5.7.16.1 General
The purpose of the procedure shown in FIG. 8 is to send application layer
measurement reports to the network.
5.7.16.2 Initiation
A UE capable of application layer measurement reporting in RRC_CONNECTED
may initiate the procedure when configured with application layer measurement, i.e.
when appLayerMeasConfig and SRB4 have been configured by the network.
Upon initiating the procedure, the UE shall:

| | |
|---|---|
| 1> | for each measConfigAppLayerId: |
| | 2> if the UE AS has received application layer measurement report from upper |

| | |
|---|---|
| | layers which has not been transmitted; and |
| 2> | if the application layer measurement reporting has not been suspended for the |
| | measConfigAppLayerId associated with the application layer measurement |
| | report according to clause 5.3.5.13d: |

| | |
|---|---|
| 3> | set the MeasurementReportAppLayerContainer in the |
| | MeasurementReportAppLayer message to the received value in the |
| | application layer measurement report; |

| | |
|---|---|
| 2> | set the measConfigAppLayerId in the MeasurementReportAppLayer message |
| | to the value of the measConfigAppLayerId received together with application |
| | layer measurement report information; |
| 2> | if session start or stop information has been received from upper layers for |
| | the measConfigAppLayerId: |

| | |
|---|---|
| 3> | set the appLayerSessionStatus to the received value of the application |
| | layer measurement information; |

| | |
|---|---|
| 2> | if RAN visible application layer measurement report has been received from |
| | upper layers: |

| | |
|---|---|
| 3> | for each appLayerBufferLevel value in the received RAN visible |
| | application layer measurement report: |

| | |
|---|---|
| 4> | set the appLayerBufferLevel values in the appLayerBufferLevelList to |
| | the buffer level values received from the upper layer in the order with |
| | the first appLayerBufferLevel value set to the newest received buffer |
| | level value, the second appLayerBufferLevel value set to the second |
| | newest received buffer level value, and so on until all the buffer level |
| | values received from the upper layer have been assigned or the |
| | maximum number of values have been set according to |
| | appLayerBufferLevel, if configured; |

| | |
|---|---|
| 3> | set the playoutDelayForMediaStartup to the received value in the RAN |
| | visible application layer measurement report, if any; |
| 3> | for each protocol data unit (PDU) session identifier (ID) value indicated in |
| | the received RAN visible application layer measurement report, if any: |

| | |
|---|---|
| 4> | set the PDU-SessionID field in the pdu-SessionIdList to the indicated |
| | PDU session ID value; |

| | |
|---|---|
| 2> | if the encoded RRC message is larger than the maximum supported size of |
| | one PDCP SDU specified in TS 38.323 [5]: |

| | |
|---|---|
| 3> | if the RRC message segmentation is enabled based on the field rrc- |
| | SegAllowed received in appLayerMeasConfig: |

| | |
|---|---|
| 4> | initiate the UL message segment transfer procedure as specified in |
| | clause 5.7.7; |

| | |
|---|---|
| 3> | else: |
| | 4> discard the RRC message; |

| | |
|---|---|
| 2> | else: |

| | |
|---|---|
| 3> | submit the MeasurementReportAppLayer message to lower layers for |
| | transmission upon which the procedure ends. |

The base station 3-15 may deliver the measurement result report to a destination server (e.g., a trace collection entity (TCE) or a measurement collection entity (MCE)) 3-65 collecting the measurement report 3 in operation 3-70.

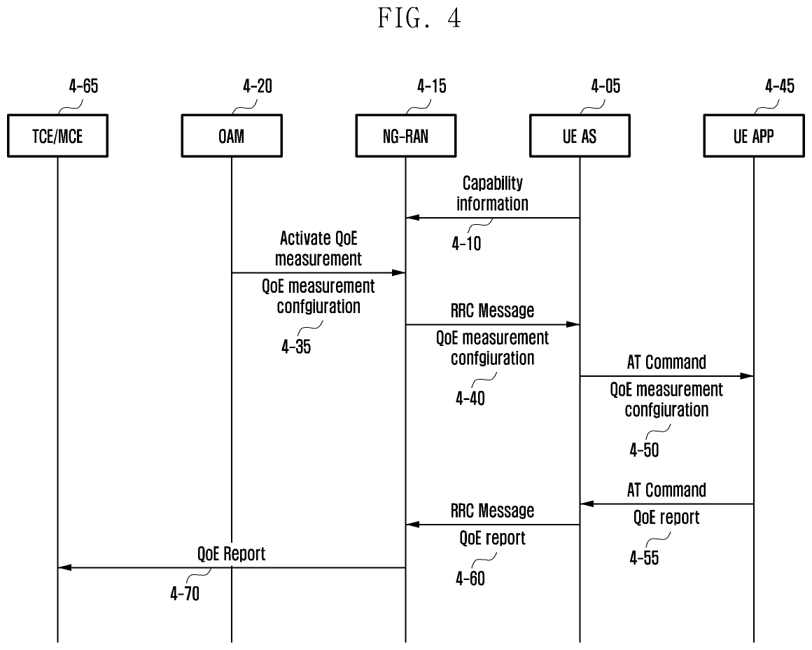

FIG. 4 is a flowchart illustrating a procedure for configuring and/or reporting a management-based QoE measurement according to an embodiment of the disclosure.

In the embodiment of FIG. 4, a UE AS 4-05 may be defined as a terminal, and an NG-RAN 4-15 may be defined as a base station. The UE AS 4-05 may be defined as the AS layer of the UE, and the UE APP 4-45 may be defined as the UE application layer. Operations performed by the UE AS 4-05 and UE APP 4-45 may be interpreted as operations performed by the UE.

Referring to FIG. 4, the configuration and/or reporting procedure of the management-based QoE may be similar to the signaling-based procedure (e.g., FIG. 3). Therefore, in the disclosure, only the differences in management-based schemes may be described, and other procedures and descriptions may be the same as the description regarding FIG. 3, and the description of FIG. 3 is referred for the same description.

The UE AS 4-05 may transmit capability information (UECapabilityInformation) to the NG-RAN 4-15 in operation 4-10. For operations 4-10 and operations related thereto, the operation 3-10 in FIG. 3 and the related description are referred.

In the management based scheme, the OAM 4-20 may activate the QoE measurement by directly sending the QoE measurement configuration to the base station (NG-RAN) 4-15 without going through the CN in operation 4-35. For additional constitution for activating QoE measurement, the operation 3-35 in FIG. 3 is referred. The base station 4-15, which has received the QoE measurement configuration, may find a single UE or a plurality of UEs that meet a plurality of conditions (e.g., at least one of area scope, application layer capability, and service type). In addition, the base station 4-15 may transmit the QoE measurement configuration to each of the UEs through an RRC message (e.g., an RRCReconfiguration message or RRCResume) in operation 4-40.

The UE 4-05, which has received the RRC message including the QoE measurement configuration, may transmit the AT command including the QoE measurement configuration to the UE APP 4-45 in operation 4-50. The UE APP 4-45, which has received the AT command including the QoE measurement configuration, may perform measurement and transmit the AT command including the measurement result to the UE AS 4-05 in operation 4-55. The measurement result may be included in the QoE report. The UE AS 4-05, which has received the QoE report, may transmit an RRC message including the QoE report to the NG-RAN 4-15 in operation 4-60. The NG-RAN 4-15, which has received the RRC message including the QoE report, may transmit the QoE report to a TCE/MCE 4-65 in operation 4-70. For specific descriptions of 4-40, 4-50, 4-55, 4-60, and 4-70, the description of the corresponding operations in FIG. 3 is referred.

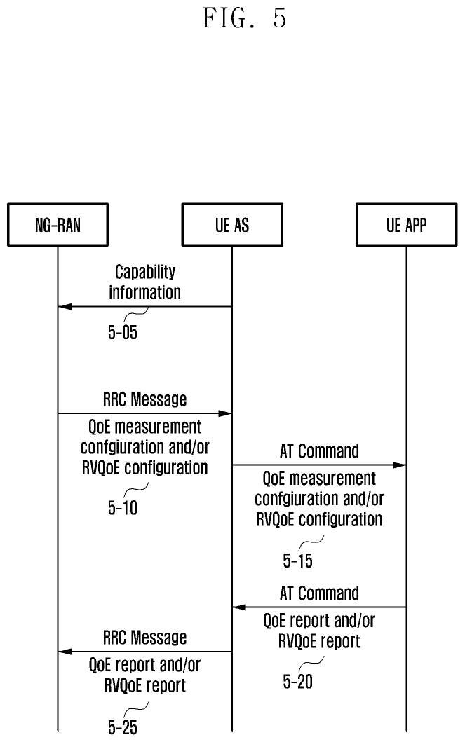

FIG. 5 is a flowchart illustrating a procedure for configuring and reporting a radio access network (RAN) visible QoE (RVQoE) measurement according to an embodiment of the disclosure.

In the embodiment of FIG. 5, a UE AS may be defined as a terminal, and an NG-RAN may be defined as a base station. The UE AS may be defined as the AS layer of the UE, and the UE APP may be defined as the UE application layer. Operations performed by the UE AS and UE APP may be interpreted as operations performed by the UE.

Referring to FIG. 5, the QoE measurements described in FIGS. 3 and 4 may be configured by the OAM, the QoE measurement reports generated according to the configuration of the OAM may be collected with TCE/MCE, and the service provider may use the QoE measurement reports for network optimization. The UE may transmit a report on the OAM-based QoE measurement to the base station, and when the base station receives the report on the OAM-based QoE measurement, it may be difficult for the base station to read or understand the measurement report. The MeasurementReportAppLayer message may include a measurement report generated by the application layer of the UE in the measurementReportAppLayerContainer, but because it is stored in OCTEC STRING format, it may be difficult for the base station or RRC layer of the base station to read or understand the measurement report. To solve the problem of making it difficult to read or understand the measurement report, the base station may use RAN visible QoE (e.g., RVQoE) measurement to read the QoE measurement report and use it for network optimization such as radio resource management. RVQoE measurements may be defined and limited to a specific service type (e.g., at least one of streaming and VR).

In First, the UE (or UE AS) may report capability information indicating whether RVQoE measurement is supported to the base station. The UE may report to the base station whether it supports RVQoE measurement by service type (e.g., at least one of streaming and VR) in operation 5-05. In this case, a UECapabilityInformation message may be used. For example, for streaming services, the UE may include or configure the ran-VisibleQoE-Streaming-MeasReport parameter in the UECapabilityInformation message, and for VR services, the UE may include or configure the ran-VisibleQoE-VR-MeasReport parameter.

By including or configuring a parameter for whether the UE supports RVQOE measurement, the base station may determine whether the UE supports the RVQOE measurement for each service type. By determining whether the UE supports the RVQOE measurement for each service type, the base station may generate the RVQOE measurement configuration and transmit it to the UE in operation 5-10. In this case, the RVQoE measurement configuration may be transmitted together with the OAM-based QoE measurement configuration. The RVQoE measurement configuration may be included in the RRCReconfiguration or RRCResume message. For example, the base station may indicate the UE to configure or release the RVQoE measurement through setup or release of the ran-VisibleParameters parameter in AppLayerMeasConfig IE. The parameter may include RAN-VisibleParameters IE, and through the RAN-VisibleParameters IE, the base station may provide some or all of the following parameters to the terminal.
RVQOE measurement report period (e.g., ran-VisiblePeriodicity): The UE AS or UE APP may transmit an RVQoE measurement report every period.
Maximum number of reportable buffer levels (e.g., numberOfBufferLevelEntries): The UE AS or UE APP may include a plurality of buffer levels when reporting the RVQoE measurements, and may include buffer levels less than the configured value.
Whether to report playout delay when media starts (e.g., reportPlayoutDelayForMediaStartup): If a value of whether to report playout delay when media starts is indicated as true, the UE AS or UE APP may include the playout delay in the RVQoE report when media starts and transmit the same. If the value of whether to report playout delay when media starts is indicated as false, the UE may not include the playout delay in the RVQoE report when media starts.

The AS layer (UE AS) of the UE may transmit the above-described configuration information to the APP layer (UE APP) of the UE in operation 5-15. The UE AS may transmit the above configuration information to the UE APP using an AT command. In this case, the RVQoE measurement configuration may be transmitted together with the OAM-based QoE measurement configuration. The APP of the UE may perform the QoE measurement based on the RVQoE measurement configuration information and generate an RVQoE measurement report based on the QoE measurement. The UE APP may transmit the generated RVQoE measurement report to the AS layer of the UE in operation 5-20. The UE APP may transmit the RVQoE measurement report to the UE AS using the AT command. In this case, the RVQoE measurement report may be transmitted together with the OAM-based QoE measurement report.

The AS layer of the UE, which has received the RVQoE measurement report, may deliver the RVQoE measurement report to the base station in operation 5-25. The UE AS may deliver the RVQoE measurement report to the base station using the RRC message. In this case, the RVQoE measurement report may be delivered together with the OAM-based QoE measurement report. In operation 5-25, the RVQoE measurement report may be transmitted via RAN-VisibleMeasurements IE in the MeasurementReportAppLayer message. The RAN-VisibleMeasurements IE may include some or all of the following parameters.
A buffer level list of an APP layer (e.g., appLayerBufferLevelList): The buffer level list of the APP layer may include a plurality of buffer levels measured by the UE APP. The number included by numberOfBufferLevelEntries during RVQoE configuration may be limited.
Playout delay (e.g. playoutDelayForMediaStartup): the playout delay may indicate the playout delay in ms when media starts. The UE may include a playout delay parameter when reportPlayoutDelayForMediaStartup is configured as true during RVQoE configuration.
PDU session ID list (e.g., pdu-SessionIdList): The PDU session ID list may indicate the PDU session(s) used in the application data flow that is the target of RVQOE measurement. The base station may know for which PDU session(s) the RVQOE values (e.g., buffer level and playout delay) have been measured through the PDU session ID list, and the base station may optimize resource allocation and scheduling for the PDU session(s) depending on which RVQoE values (e.g., buffer level and playout delay) are measured for the corresponding PDU session(s).

The base station may read the RVQoE report and utilize the RVQoE report to perform network optimization. For example, the base station may improve the QoE of the UE experiencing poor QoE for a specific service by allocating a larger amount of radio resources to the corresponding UE.

The concepts described below may be additionally applied or used to the previously described embodiments of FIGS. 3, 4, and 5.

In an LTE system, the QoE measurements (e.g., descriptions with respect to FIGS. 3 and 4) may be supported only in a connected mode (RRC_CONNECTED). On the other hand, the NR system may support the QoE measurements even in an inactive mode (RRC_INACTIVE) or idle mode (RRC_IDLE) for multimedia broadcast multicast services (MBMS) or multicast/broadcast services (MBS). In the future, the NR system may support the QoE measurements in the inactive and idle modes for various service types as well as MBS. In the embodiment of the disclosure, the QoE measurement is described in relation to the MBS service for convenience of explanation, but the technical features described in the embodiment of the disclosure are not limited to this, and may be applied to various service types in the connected mode and/or inactive and/or idle mode.

As an embodiment of the disclosure, the service type included in the QoE configuration information in operations 3-30, 3-35, 3-40, 3-50, 4-35, and 4-40 to indicate the QoE measurement for MBS service may define an MBS service, MBS broadcast service, or MBS multicast service. For example, in 3-40, one value of the serviceType parameters may include the MBS broadcast service or MBS multicast service. The UE (e.g., UE AS), which has received this, may transmit the QoE configuration information to an upper layer (e.g., UE APP) by considering the corresponding value. In this case, serviceType may also be included and transmitted.

As an embodiment of the disclosure, a new indicator may be defined and included in the QoE configuration information in operations 3-30, 3-35, 3-40, 3-50, 4-35, and 4-40 to indicate the QoE measurement for MBS service. The new indicator is hereinafter defined as indicator A for convenience of explanation, but is not limited thereto. Indicator A may be a newly defined indicator to indicate the QoE measurement for MBS service. If Indicator A is included or configured in the QoE configuration information, it may indicate that it is the QoE configuration information for MBS, MBS broadcast, or MBS multicast.

As an embodiment of the disclosure, Indicator A may indicate that the (connection mode and) received QoE configuration information is the QoE configuration information related to the QoE measurement in idle mode and inactive mode. This is because the MBS (broadcast and/or multicast) service is a service that is performed even in (connected mode and) idle mode and inactive mode. Indicator A may be a separate indicator from the service type indicator. This is because MBS may be an intermediate technology to service a specific service type. For example, if Service type in the QoE configuration information is a streaming service and Indicator A is included or configured in the QoE configuration information, the UE may perform the QoE measurement/reporting only in case where the streaming service is provided by MBS or MBS broadcast or MBS multicast. Even if the UE receives the streaming service, the QoE measurement/reporting may not be performed unless it is received by MBS, MBS broadcast, or MBS multicast. For example, if this is explained in detail through the embodiment of FIG. 3, the UE AS may receive Indicator A from the base station in operation 3-40 through an RRC Reconfiguration, RRC Resume, or RRC Release message. The UE AS may transmit the received Indicator A (e.g., together with the service type) to the upper layer (UE APP). Therefore, the UE APP may perform the QoE measurement/reporting only in case where the streaming services are provided by MBS or MBS broadcast or MBS multicast. As an embodiment of the disclosure, Indicator A may be transmitted by being included in the QoE configuration container (e.g., measConfigAppLayerContainer) within the RRC Reconfiguration, RRC Resume, or RRC Release message. However, this does not limit Indicator A to include only the QoE configuration container (e.g., measConfigAppLayerContainer).

As an embodiment of the disclosure, the QoE configuration container (e.g., measConfigAppLayerContainer) may configure/include an area information indicator (e.g., LocationFilter) where the UE must perform the QoE measurement. In case where LocationFilter is not configured, the UE may perform the QoE measurement regardless of the UE's location. The LocationFilter may be configured to a list of cell IDs, a list of geographic areas (e.g., polygon or circular area), or a combination thereof, but is not limited thereto. In conventional QoE measurement (e.g., LTE, Release 17 NR), the UE may perform the QoE measurement only in the connected mode. Therefore, in the connected mode, the UE APP may receive the LocationFilter configuration through QoE configuration, perform the QoE measurement according to the LocationFilter in the connected mode, and generate a report. However, in the case of MBS services, the UE may receive services not only in the connected mode but also in the inactive and idle modes, and the QoE measurements for MBS services may be performed not only the in connected mode but also in the inactive and idle modes. In the inactive and idle modes, the UE may be mobile. That is, even if the UE receives the QoE configuration for the MBS service in the connected mode, the UE may receive the MBS service, perform the QoE measurement, and generate and store a QoE report while moving in the inactive and idle mode. (The QoE measurement reports generated in the inactive and idle modes may not be reported immediately and may be reported to the connected base station later after transitioning to the connected mode.) The OAM or CN or base station may limit the QoE measurement or report on the MBS service of the UE to specific areas. For this purpose, the LocationFilter may be used rather than defining/configuring new area information. The area for QoE measurement for MBS service and the area for reporting the QoE measurement for MBS service may be the same or different.

As an embodiment of the disclosure, the UE may perform the QoE measurement for MBS (broadcast and/or multicast) service or QoE measurement in the inactive/idle mode according to the following procedure.

1) The UE may report to the base station whether it supports the QoE measurement for MBS (broadcast and/or multicast) service or whether it supports the QoE measurement in the inactive/idle mode. For example, the UE may report the above information to the base station through UE capability information reporting.

2) The base station may transmit the QoE measurement configuration information for MBS (broadcast and/or multicast) service or QoE measurement configuration information in the inactive/idle mode to the UE. In this case, the UE may be in the connected mode. The corresponding configuration information may include LocationFilter.

3) The UE in the connected mode, which has received the above configuration information, may transition to the inactive or idle mode. In the inactive or idle mode, the UE may perform the QoE measurement (for MBS services) while moving across multiple areas (e.g., multiple cells) and store the measurement results. In case where the UE in the inactive or idle mode with mobility is located inside the area indicated by the LocationFilter, the UE may maintain/perform the QoE measurement, store the measurement report, and start a new QoE measurement session. Conversely, in case where the UE in the inactive or idle mode with mobility is located outside the area indicated by the LocationFilter, the UE may maintain/perform existing QoE measurements and store measurement reports, but may not be able to start a new QoE measurement session.

4) The UE APP may deliver the measured QoE report to the UE AS layer and the UE AS may store the QoE report.

5) The UE may transition to the connected mode.

6) The UE in the connected mode may transmit the QoE measurement report or availability indicator using one of the options below. (The availability indicator may be an indicator that the UE is storing the QoE measurement report to the base station, and the base station, which has received this, may transmit, to the UE, a collection request for requesting the transmission of the QoE measurement report. The UE, which has received the collection request for QoE measurement reporting, may perform the QoE measurement report to the base station according to the collection request.)

Option A) In case where the base station supports 1) collection (retrieval) of Release 18 QoE measurements or reports, 2) collection of QoE measurements or reports for MBS services, or 3) QoE measurement in the inactive/idle mode, or report collection, the UE may transmit the QoE report measured and stored in the inactive/idle mode or its availability indicator to the corresponding base station. The base station may transmit to the UE whether 1), 2), and 3) mentioned above are supported in relation to the collection of QoE measurement reports through an SIB. Alternatively, the base station may transmit to the UE whether 1), 2), and 3) mentioned above are supported in relation to the collection of QoE measurement reports through a dedicate message (e.g., RRC Setup or RRC Reconfiguration or RRC Resume). That is, in Option A, the UE may not check LocationFilter when reporting the QoE measurement or availability indicator. For example, in case where the QoE measurement report is stored in the UE AS, the LocationFilter contained in the QoE configuration container cannot be seen by the UE AS (RRC) layer, so the UE does not check whether the connected base station is inside or outside the LocationFilter when reporting the measurement. Otherwise, if the base station only supports/allows the QoE measurement reporting or availability indicator reporting, the UE may report the QoE measurement report to the base station.

Option B) The UE AS in the connected mode may transmit an indicator to the APP layer to inquire whether the LocationFilter is satisfied (i.e., internal or external) before reporting the QoE measurement or availability indicator (e.g., through the AT Command). The APP layer, which has received this, may reply to the AS layer whether the current location of the UE satisfies the LocationFilter (e.g., through the AT Command). In case where the UE AS has received from the APP that the current location of the UE satisfies the LocationFilter (i.e., located inside the area indicated by the LocationFilter), the UE may perform reporting of the QoE measurement or availability indicator to the connected base station. In case where the UE AS has received from the APP that the current location of the UE does not satisfy the LocationFilter (i.e., is located outside the area indicated by the LocationFilter), the UE may not perform reporting of the QoE measurement or availability indicator to the connected base station.

Option C) The UE may receive area information (AS area scope) that may be used in the AS layer from the base station through the QoE configuration information in operations 3-40 and 4-40. The AS area scope may be defined/included outside the QoE configuration container (e.g., measConfigAppLayerContainer) so that it can be read from the AS layer. The AS area scope may be defined as a cell list and tracing area list. The UE AS layer may determine whether the currently connected base station satisfies the AS area scope (whether the UE is inside or outside the area scope). If the UE AS identifies that the current location satisfies the AS area scope (i.e., within the AS area scope), the UE may perform reporting of the QoE measurement or availability indicator to the connected base station. If the UE AS identifies that the current location does not satisfy the AS area scope (i.e., outside the AS area scope), the UE may not perform reporting of the QoE measurement or availability indicator to the connected base station. The AS area scope may be included in the QoE configuration information in operations 3-30, 3-35, 3-40, 3-50, 4-35, and 4-40. As an embodiment of the disclosure, the OAM or CN or base station may configure the AS area scope to be the same as the LocationFilter. In an embodiment of the disclosure, the AS area scope may be defined the same as LocationFilter. In this case, the area information (i.e., LocationFilter) used for the QoE measurement in the UE APP and the area information (AS area scope) used for the QoE reporting in the UE AS may be the same. As an embodiment of the disclosure, the OAM, CN, or base station may configure the AS area scope to a value different from the LocationFilter. In this case, the area information (i.e., LocationFilter) used for the QoE measurement in the UE APP and the area information (AS area scope) used for the QoE reporting in the UE AS may be different.

As an embodiment of the disclosure, RAN visible QoE measurement may be used for the QoE measurement in the inactive/idle mode. When the OAM or CN configures the QoE measurement in the inactive/idle mode to the UE, it may indicate the area it manages (relatively large area information) (e.g. LocationFilter). On the other hand, since RAN visible QoE is configured by the base station, the corresponding base station may be interested only in measuring RAN visible QoE in a relatively narrow area (e.g., cells the base station manages or neighboring base stations or cells). The base station that configures RVQoE may not be interested in measuring RVQoE in other areas. Therefore, a separate area scope (e.g., RVQoE area scope) may be defined in the RVQoE configuration in operation 5-10 in the inactive/idle mode. The UE may perform the RVQoE measurement and/or reporting only within the RVQoE area scope. In other areas, the QoE measurement and/or reporting may be performed but the RVQoE measurement and/or reporting may not be performed. For example, the RVQoE area scope may be a subset of LocationFilter. When configuring the RVQoE area scope, the base station may configure it to some area included in the LocationFilter. To do this, the base station may receive the configuration of area information (e.g., LocationFilter) from the OAM or CN to configure the RVQoE are scope, and configure the RVQoE are scope within the area information for the UE. For example, since the conventional LocationFilter is contained in the QoE configuration container and cannot be read by the base station, the newly defined area information (e.g., the same information as LocationFilter) may be included in the explicit NGAP and/or XnAP parameters outside the QoE configuration container so that the base station may identify the area information.

As an embodiment of the disclosure, the UE AS, which has received the RVQoE area scope configured by the base station, may deliver the RVQoE area scope to the APP layer, and accordingly, the APP may perform RVQoE measurement in case where the UE is located within the corresponding RVQoE area scope. As an embodiment of the disclosure, the UE AS, which has received the RVQoE area scope configured by the base station, may not transmit the RVQoE area scope to the APP layer. Therefore, the UE APP may perform RVQoE measurement anywhere (without checking the RVQoE area scope) and deliver the measurement result report to the AS layer. Instead, when the UE AS layer receives the measurement result report, in case where the UE AS identifies that the UE location is outside the RVQoE area scope, or the location information included in the received RVQOE measurement report (indicating information at which location the UE APP has performed the RVQoE measurement) is outside the RVQOE area scope, the UE AS may discard the corresponding RVQoE measurement report without storing it.

Conventional QoE measurements may not require time information because they are measured only in the connected mode and may be immediately reported to the base station. However, the QoE measured value in the inactive/idle mode may be stored in the inactive/idle mode and later reported after the UE transitions to the connected mode, so the QoE measurement timing of the UE and the QoE measurement report reception timing of the network (base station, OAM, or MCE) may be significantly different. As an embodiment of the disclosure, time information (timestamp) may be included in the QoE measurement report measured by the UE in the inactive/idle mode.

As an embodiment of the disclosure, the time information may indicate the point in time when the actual (RV) QoE value (e.g., buffer level, playout delay) was measured by the UE APP. As an embodiment of the disclosure, this may be time information when the UE APP delivers the QoE measurement report to the UE AS. As an embodiment of the disclosure, the time information may be included for each measured value (e.g., buffer level, playout delay) in the QoE measurement report message or AT command (e.g., 3-55, 3-60, 3-70, 5-20, 5-25).

In an embodiment of the disclosure, for the same metric (e.g., buffer level) within one QoE measurement report message or AT command (e.g., 3-55, 3-60, 3-70, 5-20, 5-25) in case where a plurality of QoE measurement results is included, only one piece of time information (e.g., the measurement time of a first measurement value) may be included. For example, in case where the measurement or reporting period is configured by the base station or OAM or defined as a fixed value in a standard, the timing of the remaining measurement values may be inferred from only one (e.g., the first) measurement value.

As an embodiment of the disclosure, for the plurality of metrics or plurality of measurement results included in one QoE measurement report message or AT command (e.g., 3-55, 3-60, 3-70, 5-20, 5-25), only one time information may be included. In case where their measurement times are not significantly different, only one temporal information may be included to minimize signaling overhead.

As an embodiment of the disclosure, in case where the UE is configured and performs periodic QoE measurement, the time information is not included for each QoE measurement report message or AT command (e.g., 3-55, 3-60, 3-70, 5-20, 5-25), and is only included in the first QoE measurement report message or AT command for each QoE session. For example, in case where the measurement or report period is configured by the base station or OAM or defined as a fixed value in the standard, the remaining time information may be inferred with only one time information report. For example, time information may be included whenever appLayerSessionStatus is indicated as started (i.e., whenever it indicates that a QoE session has started). When appLayerSessionStatus is not included or is indicated as stopped, the time information may not be included to reduce signaling overhead.

As an embodiment of the disclosure, in case where the UE is configured to perform event-based (RV) QoE measurement, the UE may include the time information in the QoE measurement report at each event occurrence.

In case of the (RV) QoE measurements in the inactive/idle mode, not only time information but also location information may be included in the QoE measurement report (e.g., 3-55, 3-60, 3-70, 5-20, 5-25). That is, in the inactive/idle mode, the UE may receive services (e.g., MBS) from multiple base stations or cells while moving. The UE may receive services from different base stations or cells depending on its location and obtain different (RV) QoE measurement results accordingly. For example, from the OAM or base station perspective, it may be important to determine whether the UE's (RV) QoE performance was poor when receiving service from a certain location or cell. Accordingly, the OAM or base station may optimize the network to improve service at the corresponding base station or cell. As an embodiment of the disclosure, the location information included in the QoE measurement report (e.g., 3-55, 3-60, 3-70, 5-20, 5-25) may be indicated as the PLMN(s) and/or cell ID(s) and/or tracking area(s) where the QoE value was measured.

As an embodiment of the disclosure, all location information (e.g., cell ID) that has provided the service for each QoE measurement report message or AT command (e.g., 3-55, 3-60, 3-70, 5-20, 5-25)) may be included.

As an embodiment of the disclosure, whenever the location information (e.g., cell ID) providing the service changes, the corresponding location information may be included in the QoE measurement report (e.g., 3-55, 3-60, 3-70, 5-20, 5-25). In case where the location information (e.g. cell ID) providing the service does not change, the location information may not be included in the QoE measurement report.

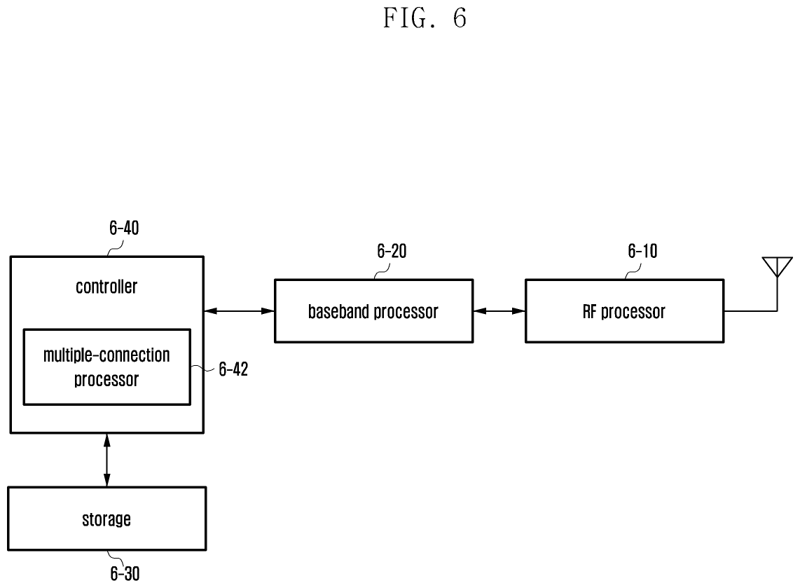

FIG. 6 is a view illustrating a structure of a UE according to an embodiment of the disclosure.

Referring to FIG. 6, the UE may include a radio frequency (RF) processor 6-10, a baseband processor 6-20, a storage 6-30 (e.g., memory), and a controller 6-40.

The RF processor 6-10 may perform functions for transmitting and/or receiving signals through a wireless channel, such as band conversion and amplification of signals. That is, the RF processor 6-10 may up-convert a baseband signal provided from the baseband processor 6-20 into an RF band signal and then transmit the RF band signal through an antenna, and may down-convert an RF band signal received through the antenna into a baseband signal. For example, the RF processor 6-10 may include a transmission filter, a reception filter, an amplifier, a mixer, an oscillator, a digital-to-analog converter (DAC), an analog-to-digital converter (ADC), or the like. Although only one antenna is illustrated in the drawing, the UE may include a plurality of antennas. In addition, the RF processor 6-10 may include a plurality of RF chains. Further, the RF processor 6-10 may perform beamforming. For beamforming, the RF processor 6-10 may adjust the phase and magnitude of each of the signals transmitted/received through the plurality of antennas or antenna elements. Further, the RF processor may perform multiple input multiple output (MIMO), and may receive multiple layers when performing the MIMO operation.

The baseband processor 6-20 may perform the function of conversion between a baseband signal and a bit stream according to the physical layer specifications of a system. For example, when transmitting data, the baseband processor 6-20 may generate complex symbols by encoding and modulating a transmission bit string. In addition, when receiving data, the baseband processor 6-20 may reconstruct a reception bit string by demodulating and decoding the baseband signal provided from the RF processor 6-10. For example, in the case of following the orthogonal frequency division multiplexing (OFDM) scheme, when transmitting data, the baseband processor 6-20 may generate complex symbols by encoding and modulating the transmission bit stream, map the complex symbols to a subcarrier, and then constitute OFDM symbols through inverse fast Fourier transform (IFFT) operation and cyclic prefix (CP) insertion. In addition, when receiving data, the baseband processor 6-20 may divide the baseband signal provided from the RF processor 6-10 into OFDM symbol units, reconstruct signals mapped to subcarriers through a fast Fourier transform (FFT) operation, and then reconstruct a reception bit string through demodulation and decoding.

The baseband processor 6-20 and the RF processor 6-10 may transmit and receive signals as described above. Accordingly, the baseband processor 6-20 and the RF processor 6-10 may be referred to as a transmitter, a receiver, a transceiver, and/or a communicator. Further, at least one of the baseband processor 6-20 and the RF processor 6-10 may include a plurality of communication modules to support a plurality of different radio access technologies. In addition, at least one of the baseband processor 6-20 and the RF processor 6-10 may include different communication modules to process signals of different frequency bands. For example, the different radio access technologies may include a wireless local area network (LAN) (e.g., IEEE 802.11), a cellular network (e.g., LTE), or the like. In addition, the different frequency bands may include a super-high frequency (SHF) (e.g., 2.NRHz or NRHz) band or millimeter wave (mmWave) (e.g., 60 GHZ) band.

The storage 6-30 may store data such as a basic program for operating the UE, an application program, and configuration information. In addition, the storage 6-30 may provide the stored data according to a request from the controller 6-40.

The controller 6-40 may control the overall operations of the UE. For example, the controller 6-40 may transmit and/or receive signals through the baseband processor 6-20 and the RF processor 6-10. In addition, the controller 6-40 may record and read data in the storage 6-30. To do this, the controller 6-40 may include at least one processor. For example, the controller 6-40 may include a communication processor (CP) that performs control for communication and an application processor (AP) that controls an upper layer such as an application program. In addition, the controller 6-40 may further include a multiple-connection processor 6-42 to support multiple connection. The controller 6-40 may control the operations of the UE according to various embodiments of the disclosure. In addition, the controller 6-40 may control the operations of the UE AS, UE APP according to various embodiments of the disclosure.

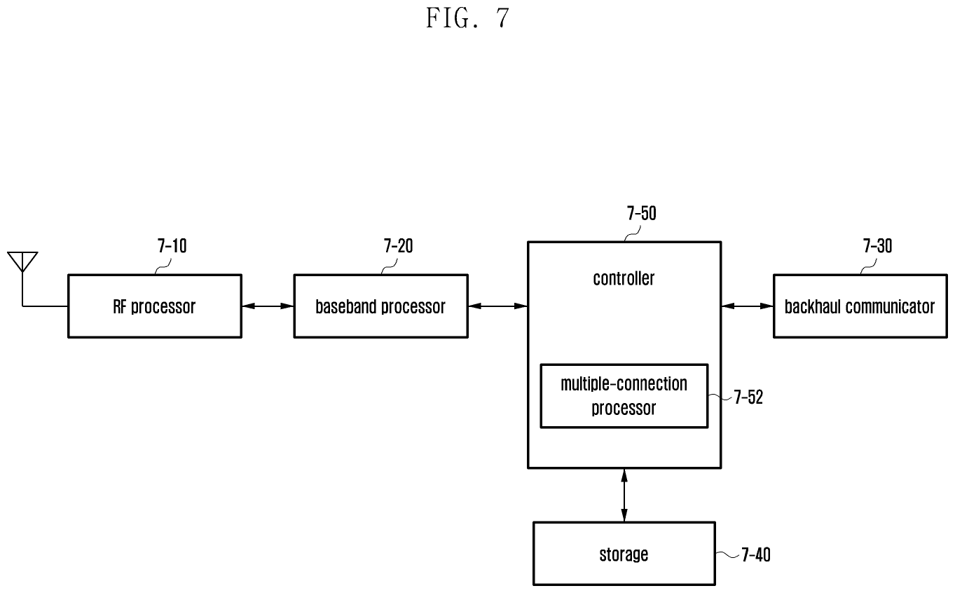

FIG. 7 is a view for explaining a structure of a base station according to an embodiment of the disclosure.

Referring to FIG. 7, the base station may be constituted to include an RF processor 7-10, a baseband processor 7-20, a backhaul communicator 7-30, a storage 7-40 (e.g., memory), and a controller 7-50.

The RF processor 7-10 may perform functions for transmitting and/or receiving signals through a radio channel, such as band conversion or amplification of signals. That is, the RF processor 7-10 may up-convert a baseband signal provided from the baseband processor 7-20 into an RF band signal and then transmit the RF band signal through an antenna, and may down-convert an RF band signal received through the antenna into a baseband signal. For example, the RF processor 7-10 may include a transmission filter, a reception filter, an amplifier, a mixer, an oscillator, a DAC, an ADC, or the like. Although only one antenna is illustrated in the drawing, a first access node may include a plurality of antennas. In addition, the RF processor 7-10 may include a plurality of RF chains. Further, the RF processor 7-10 may perform beamforming. For beamforming, the RF processor 7-10 may adjust the phase and magnitude of each of the signals transmitted and/or received through the plurality of antennas or antenna elements. The RF processor may perform a downward MIMO operation by transmitting one or more layers.

The baseband processor 7-20 may perform the function of conversion between a baseband signal and a bit stream according to the physical layer specifications of a first radio access technology. For example, when transmitting data, the baseband processor 7-20 may generate complex symbols by encoding and modulating a transmission bit string. In addition, when receiving data, the baseband processor 7-20 may reconstruct a reception bit string by demodulating and decoding the baseband signal provided from the RF processor 7-10. For example, in the case of following the OFDM scheme, when transmitting data, the baseband processor 7-20 may generate complex symbols by encoding and modulating the transmission bit stream, map the complex symbols to a subcarrier, and then construct OFDM symbols through IFFT operation and CP insertion. In addition, when receiving data, the baseband processor 7-20 may divide the baseband signal provided from the RF processor 7-10 into OFDM symbol units, reconstruct signals mapped to subcarriers through an FFT operation, and then reconstruct a reception bit string through demodulation and decoding. The baseband processor 7-20 and the RF processor 7-10 may transmit and receive signals as described above. Accordingly, the baseband processor 7-20 and the RF processor 7-10 may be referred to as a transmitter, a receiver, a transceiver, a communication unit, or a wireless communication unit.

The backhaul communicator 7-30 may provide an interface for communicating with other nodes in the network. That is, the backhaul communicator 7-30 may convert the bit string transmitted from a main base station to another node, e.g., an assistance base station, a core network, etc. into a physical signal and converts the physical signal received from another node into a bit stream.

The storage 7-40 may store a basic program for operating the main base station, application programs, or data such as configuration information. In addition, the storage 7-40 may provide the stored data according to a request from the controller 7-50.

The controller 7-50 may control the overall operations of the main base station. For example, the controller 7-50 may transmit and/or receive signals through the baseband processor 7-20 and the RF processor 7-10 or through the backhaul communication unit 7-30. In addition, the controller 7-50 may record and read data in the storage 7-40. To do this, the controller 7-50 may include at least one processor. In addition, the controller 7-50 may further include a multiple-connection processor 7-52 to support multiple connection. The controller 7-50 may control the operations of the base station and/or operation of NG-RAN according to various embodiments of the disclosure.

Methods according to the embodiments disclosed in the claims or specification of the disclosure may be implemented by hardware, software, or a combination of hardware and software.

In case where the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments disclosed in the claims or specification of the disclosure.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, the programs may be stored in memory constructed with any combination of some or all of them. In addition a plurality of respective constituent memories may be included.

In addition, the programs may be stored in an attachable storage device which may access the electronic device through communication networks constituted with a communication network such as the Internet, Intranet, Local Area Network (LAN), wide area network (WAN), and storage area network (SAN) or a combination thereof. Such a storage device may access the electronic device performing the embodiments of the disclosure via an external port. Further, a separate storage device on the communication network may access a device performing the embodiments of the disclosure.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a base station in a wireless communication system, the method comprising:
transmitting, to a terminal, a first radio resource control (RRC) message including configuration information associated with an application layer measurement of the terminal;
transmitting, to the terminal, a second RRC message including report information associated with a report of the application layer measurement performed in an RRC inactive or an RRC idle; and
receiving, from the terminal, a measurement report associated with the application layer measurement performed in the RRC inactive or the RRC idle,
wherein the configuration information is applied to the RRC idle or the RRC inactive.

2. The method of claim 1, further comprising:
receiving, from the terminal, an indicator associated with the application layer measurement,
wherein, in case that the indicator is received, the base station transmits, to the terminal, the second RRC message allowing the measurement report.

3. The method of claim 1, further comprising:
receiving, from the terminal, an indicator associated with the application layer measurement based on the second RRC message; and
transmitting, to the terminal, a message allowing the measurement report.

4. The method of claim 1,
wherein the first RRC message is an RRC reconfiguration message or an RRC resume message transmitted to the terminal before the terminal transitions to the RRC idle or RRC inactive, and
wherein the second RRC message is an RRC reconfiguration message or an RRC resume message transmitted to the terminal after the terminal transitions from the RRC idle or RRC inactive to RRC connected.

5. The method of claim 1, further comprising:
receiving information associated with a multicast broadcast service (MBS) service type from a core network (CN) entity,
wherein the information indicates that configuration information for quality of experience (QoE) applies to a broadcast or a multicast.

6. A method performed by a terminal in a wireless communication system, the method comprising:
receiving, from a base station, a first radio resource control (RRC) message including configuration information associated with an application layer measurement of the terminal;
performing the application layer measurement in an RRC inactive or an RRC idle based on the first RRC message;
receiving, from the base station, a second RRC message including report information associated with a report of the application layer measurement; and
transmitting, to the base station, a measurement report associated with the application layer measurement,
wherein the configuration information is applied to the RRC idle or the RRC inactive.

7. The method of claim 6, further comprising:
transmitting, to the base station, an indicator associated with the application layer measurement,
wherein the second RRC message allows the measurement report.

8. The method of claim 6, further comprising:
transmitting, to the base station, an indicator associated with the application layer measurement based on the second RRC message; and
receiving, from the base station, a message allowing the measurement report.

9. The method of claim 6,
wherein the first RRC message is an RRC reconfiguration message or an RRC resume message received before the terminal transitions to the RRC idle or RRC inactive, and
wherein the second RRC message is an RRC reconfiguration message or an RRC resume message received after the terminal transitions from the RRC idle or RRC inactive to RRC connected.

10. The method of claim 6,
wherein the base station receives information associated with a multicast broadcast service (MBS) service type from a core network (CN) entity, and
wherein the information indicates that configuration information for quality of experience (QoE) applies to a broadcast or a multicast.

11. A base station in a wireless communication system, the base station comprising:
a transceiver; and
a controller configured to:
transmit, to a terminal, a first radio resource control (RRC) message including configuration information associated with an application layer measurement of the terminal,
transmit, to the terminal, a second RRC message including report information associated with a report of the application layer measurement performed in an RRC inactive or an RRC idle, and
receive, from the terminal, a measurement report associated with the application layer measurement performed in the RRC inactive or the RRC idle, and
wherein the configuration information is applied to the RRC idle or the RRC inactive.

12. The base station of claim 11,
wherein the controller is configured to:
receive, from the terminal, an indicator associated with the application layer measurement, and
in case that the indicator is received, transmit, to the terminal, the second RRC message allowing the measurement report.

13. The base station of claim 11, wherein the controller is configured to:
receive, from the terminal, an indicator associated with the application layer measurement based on the second RRC message; and
transmit, to the terminal, a message allowing the measurement report.

14. The base station of claim 11,
wherein the first RRC message is an RRC reconfiguration message or an RRC resume message transmitted to the terminal before the terminal transitions to the RRC idle or RRC inactive, and
wherein the second RRC message is an RRC reconfiguration message or an RRC resume message transmitted to the terminal after the terminal transitions from the RRC idle or RRC inactive to RRC connected.

15. The base station of claim 11,
wherein the controller is configured to receive information associated with a multicast broadcast service (MBS) service type from a core network (CN) entity, and
wherein the information indicates that configuration information for quality of experience (QoE) applies to a broadcast or a multicast.

16. A terminal in a wireless communication system, the terminal comprising:
a transceiver; and
a controller configured to:
receive, from a base station, a first radio resource control (RRC) message including configuration information associated with an application layer measurement of the terminal,
perform the application layer measurement in an RRC inactive or an RRC idle based on the first RRC message,
receive, from the base station, a second RRC message including report information associated with a report of the application layer measurement, and
transmit, to the base station, a measurement report associated with the application layer measurement,
wherein the configuration information is applied to the RRC idle or the RRC inactive.

17. The terminal of claim 16,
wherein the controller is configured to transmit, to the base station, an indicator associated with the application layer measurement, and
wherein the second RRC message allows the measurement report.

18. The terminal of claim 16, wherein the controller is configured to:
transmit, to the base station, an indicator associated with the application layer measurement based on the second RRC message; and
receive, from the base station, a message allowing the measurement report.

19. The terminal of claim 16,
wherein the first RRC message is an RRC reconfiguration message or an RRC resume message received before the terminal transitions to the RRC idle or RRC inactive, and
wherein the second RRC message is an RRC reconfiguration message or an RRC resume message received after the terminal transitions from the RRC idle or RRC inactive to RRC connected.

20. The terminal of claim 16,
wherein the base station receives information associated with a multicast broadcast service (MBS) service type from a core network (CN) entity, and
wherein the information indicates that configuration information for quality of experience (QoE) applies to a broadcast or a multicast.
